(19) United States
(12) Patent Application Publication
(10) Pub. No.: US 2025/0198090 A1
(43) Pub. Date: Jun. 19, 2025

(54) PAPER OR PAPERBOARD BASED PACKAGING LAMINATE

(71) Applicant: Stora Enso OYJ, Helsinki (FI)

(72) Inventors: Fredrik Werner, Hammarö (SE); Erik Stenvall, Karlstad (SE); Kaj Backfolk, Lappeenranta (FI)

(73) Assignee: Stora Enso OYJ, Helsinki (FI)

(21) Appl. No.: 18/837,962

(22) PCT Filed: Feb. 27, 2023
(86) PCT No.: PCT/IB2023/051798

§ 371 Date: Aug. 13, 2024

(30) Foreign Application Priority Data
Feb. 28, 2022 (SE) 2250271-0

(51) Int. Cl. D21J 1/08; B32B 27/10; B32B 27/32; B65D 25/14; D21H 19/04

(52) U.S. Cl. CPC D21J 1/08; B32B 27/10; B32B 27/32; B65D 25/14; D21H 19/04; B32B 2250/02; B32B 2255/12; B32B 2255/205; B32B 2255/26; B32B 2255/28; B32B 2307/31; B32B 2307/7246; B32B 2553/00

(57) ABSTRACT

The present invention relates to a paper or paperboard based packaging laminate comprising: a paper or paperboard base layer, a tie layer, a metallized film layer, and a heat-sealing layer, wherein the base layer has an inner side and an outer side, the metallized film layer is attached to the inner side of the base layer by the tie layer, and the heat-sealing layer is attached to the metallized film layer, wherein the tie layer and the heat-sealing layer are formed of a polyethylene independently selected from the group consisting of a low-density polyethylene (LORE), a linear low-density polyethylene (LLDPE), a polyethylene ionomer, a polyethylene plastomer and combinations thereof, and wherein the metallized film layer comprises a metallization layer formed on a substrate film comprising a polyethylene selected from the group consisting of medium-density polyethylene (MOPE), high-density polyethylene (HOPE) and combinations thereof.

### TECHNICAL FIELD

The present disclosure relates to paper and paperboard based packaging materials. More specifically, the present disclosure relates to paper and paperboard based packaging laminates having a low oxygen transmission rate (OTR) at high relative humidities (RH).

### BACKGROUND

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid packaging board. In liquid packaging board, polyolefin coatings are frequently used as liquid barrier layers, heat-sealing layers and as adhesive tie layers. However, the recycling of such polymer coated board is difficult since it is difficult to separate the polymers from the fibers.

Also, in many cases the gas barrier properties of the polymer coated paperboard are still insufficient unless the coating layers are thick or combinations of different polymer coating layers are used. Therefore, in order to ensure high gas barrier properties, the polymer coated paperboard is often combined with one or more layers of aluminum foil. However, the addition of polymer and aluminum layers add significant costs and the combination of polymer coating layers and aluminum foils makes recycling of the materials more difficult. Also, due to its high carbon footprint there is a wish to replace aluminum foils in paper and paperboard based packaging materials.

Aseptic packaging for long shelf-life products such as milk and juices are usually made from liquid packaging board (LPB) comprising a multilayer paperboard based substrate, an outermost heat-sealable polyolefin (e.g. polyethylene, PE) layer and innermost layers of polyolefin and aluminum. The aluminum layer, needed to provide oxygen barrier properties, is usually incorporated between layers of polyethylene to provide the following structure: PE/paperboard/PE/aluminum/PE.

In the prior art, attempts have been made to replace the aluminum foil with more environmentally friendly and/or easier to recycle solutions, but so far with no real success. For example, microfibrillated cellulose (MFC) films and coatings have been developed, in which defibrillated cellulosic fibrils have been dispersed e.g. in water and thereafter re-organized and rebonded together to form a dense film with excellent gas barrier properties. Unfortunately, the gas barrier properties of such MFC films tend to deteriorate at and high humidity.

It has also been proposed to replace the aluminum foil with high barrier films, e.g. metallized polymer films, such as metallized LDPE or LLDPE films, which are laminated to the paper or paperboard based substrate, e.g. by an LDPE based tie layer. However, the high temperatures applied in the lamination process (heat applied by the extruded tie layer and extruded heat-sealing layer) might lead to the LDPE or LLDPE film being stretched (expanded) and then shrunk when cooled, which can cause pin holes in the thin and sensitive metallization layer affecting the gas barrier properties of the laminate negatively.

Thus, there remains a need for improved solutions to replace the combination of plastic films and aluminum foils in paper and paperboard based packaging materials, while maintaining acceptable liquid, vapor and gas barrier properties. At the same time, there is a need to replace the combination of plastic films and aluminum foils with alternatives that facilitate re-pulping and recycling of the used packaging materials.

### DESCRIPTION OF THE INVENTION

It is an object of the present disclosure to provide an alternative to the combination of plastic films and aluminum foils commonly used as barrier films for providing gas barrier properties in packaging materials, such as liquid packaging board.

It is a further object of the present disclosure, to provide a paper or paperboard based packaging laminate, such as a liquid packaging board, which provides good gas barrier properties even at higher relative humidity and temperature.

It is a further object of the present disclosure to provide a paper or paperboard based packaging laminate, which has an oxygen transfer rate (OTR), measured according to the standard ASTM D-3985 at 90% relative humidity and 38° C., of less than 15 cc/m²/24 h.

It is a further object of the present disclosure to provide a paper or paperboard based packaging laminate, such as a liquid packaging board, comprising an oxygen barrier layer which facilitates re-pulping of the board as compared to packaging laminates using conventional combinations of plastic films and aluminum foils.

It is a further object of the present disclosure to provide a paper or paperboard based packaging laminate having a reject rate according to PTS RH 021/97 of less than 30%, preferably less than 20%.

The above-mentioned objects, as well as other objects as will be realized by the skilled person in the light of the present disclosure, are achieved by the various aspects of the present disclosure.

According to a first aspect illustrated herein, there is provided a paper or paperboard based packaging laminate comprising:

a paper or paperboard base layer,

a tie layer,

a metallized film layer, and

a heat-sealing layer,

wherein the base layer has an inner side and an outer side, the metallized film layer is attached to the inner side of the base layer by the tie layer, and the heat-sealing layer is attached to the metallized film layer,

wherein the tie layer and the heat-sealing layer are formed of a polyethylene independently selected from the group consisting of a low-density polyethylene (LDPE), a linear low-density polyethylene (LLDPE), a polyethylene ionomer, a polyethylene plastomer and combinations thereof, and

wherein the metallized film layer comprises a metallization layer formed on a substrate film comprising a polyethylene selected from the group consisting of medium-density polyethylene (MDPE), high-density polyethylene (HDPE) and combinations thereof.

The invention is based on the realization that using a higher melting point MDPE or HDPE in the substrate film of the metallized film layer, combined with lower melting temperature polyethylene types in the tie layer and heat-sealing layer, counteracts the heat load effects (expansion-shrinkage) at the high temperatures and cooling used in the lamination and heat-sealing processes, thereby avoiding problems with a destroyed metallization layer due to stretching and shrinkage of the PE film. Using a higher melting point MDPE or HDPE in the substrate film of the metallized film layer may also help to counteract curl of the laminate.

In some embodiments, the paper or paperboard based packaging laminate further comprises a barrier coating layer arranged between the base layer and the tie layer, wherein said barrier coating layer comprises a water-soluble polymer in an amount of at least 50 wt %, based on the dry weight of the barrier coating layer.

A barrier coating layer comprising a water-soluble polymer in an amount of at least 50 wt % has been found to allow for effective separation of the metallized film layer from the base layer during repulping.

Furthermore, as polyethylene is the major constituent of the metallized film layer as well as the tie layer and the heat-sealing layer, these three layers can be conveniently recycled in the same fraction without further polymer separation steps.

A paper or paperboard based packaging laminate is a packaging material formed mainly from paper or paperboard. It can be made from pulp, including pulp from virgin fiber, e.g. chemical, semi-chemical, mechanical and/or thermomechanical pulps. It can also be made from broke or recycled paper. In addition to paper or paperboard, the paper or paperboard based packaging laminate may comprise additional layers or coatings designed to improve the performance and/or appearance of the packaging laminate.

The paper or paperboard based packaging laminate typically has a first outermost surface intended to serve as the outside surface, or print side, and a second outermost surface intended to serve as the inside surface of a packaging container. The side of the paper or paperboard base layer comprising the metallized film layer is intended to serve as the inside surface of a packaging container.

The inventive packaging laminate layer can provide both excellent oxygen barrier properties, water vapor barrier properties, and liquid barrier properties. Especially useful is the combination of high oxygen barrier properties and high water vapor barrier properties at high humidity and temperature enabled by the metallized film layer. The term high humidity in the context of the present disclosure generally refers to a relative humidity (RH) above 80%. The term high temperature in the context of the present disclosure generally refers to a temperature above 23° C. More specifically, the term high temperature in the context of the present disclosure may refer to a temperature in the range of 25-50° C. Oxygen barrier and water vapor barrier properties of the packaging laminates at high humidity and temperature are typically measured at a representative relative humidity (RH) of 90% and a temperature of 38° C.

The inventive packaging laminate preferably has an oxygen transfer rate (OTR), measured according to the standard ASTM D-3985 at 90% relative humidity and 38° C., of less than 15 cc/m²/24 h. This makes the inventive packaging laminate an interesting and viable alternative to conventional materials using aluminum foil layers.

The inventive packaging laminate has also been found to provide good carbon dioxide barrier properties.

Additionally, the inventive paper or paperboard based packaging laminate can provide an alternative to conventional materials using aluminum foil layers, which can more readily be repulped and recycled. Embodiments having the barrier coating layer comprising a water-soluble polymer in an amount of at least 50 wt % has been found to allow for particularly effective separation of the metallized film layer from the base layer during repulping. In some embodiments, the paper or paperboard based packaging laminate has a reject rate according to PTS RH 021/97 of less than 30%, preferably less than 20%, more preferably less than 10%.

In some embodiments, the reject obtained according to the method of PTS RH 021/97 comprises at least 70 wt %, preferably at least 80 wt %, at least 85wt %, or at least 90 wt %, of polyethylene base on dry weight of the reject. This high proportion of polyethylene in the reject is advantageous since it allows for the reject to be classified and recycled as a mono-material, i.e. as a single material.

The inventive paper or paperboard based packaging laminate is further advantageous as it may be sterilized using heat and/or steam based sterilization methods, such as autoclaving at 120° C.

The inventive paper or paperboard based packaging laminate comprises a paper or paperboard base layer.

Paper generally refers to a material manufactured in thin sheets from the pulp of wood or other fibrous substances comprising cellulose fibers, used for writing, drawing, or printing on, or as packaging material.

Paperboard generally refers to strong, thick, rigid paper or cardboard comprising cellulose fibers used for boxes and other types of packaging. Paperboard or plies thereof can either be bleached or unbleached, coated or uncoated, and produced in a variety of thicknesses, depending on the end use requirements.

In some embodiments, the base layer has a basis weight in the range of 20-500 g/m², preferably in the range of 80-400 g/m².

In some embodiments, the base layer comprises a multiply paperboard. In some embodiments the base layer is a multiply paperboard comprised of three or more plies. In some embodiments the base layer is a multiply paperboard comprised of a lower density mid-ply sandwiched between two higher density outer plies.

The structure of the inventive paper or paperboard based packaging laminate enables the use of a larger amount of recycled fibers in the paper or paperboard base layer since the barrier structure hinders the migration of fatty acids, aromas and mineral oil based compounds (e.g. MOSH and MOAH), which reduces problems with odor and smell. Thus, in some embodiments, the paper or paperboard base layer comprises at least 5 wt % recycled fibers, preferably at least 10 wt % recycled fibers, and more preferably, and more preferably 15 wt % recycled fibers. The recycled fibers may include broke, but may also comprise pre-consumer or post-consumer reject.

In some embodiments, the base layer comprises at least 10 wt %, preferably at least 30 wt %, and more preferably at least 50 wt %, of recycled fibers, based on the total fiber weight of the base layer.

In some embodiments, the base layer is surface sized. Surface sizing may be provided on one or both of the base layer surfaces. Surface sizing may be applied in one or more steps on each surface.

In some embodiments, the base layer comprises a paper or paperboard layer and a mineral coating layer on the inner side and/or the outer side of the paper or paperboard layer.

In some embodiments, the mineral coating layer comprises
50-95 wt % of a particulate mineral, and
5-50 wt % of a binder,
   based on the total dry weight of the mineral coating layer.

In some embodiments, the mineral coating layer comprises 10-35 wt % binder.

In some embodiments, the particulate mineral is selected from the group consisting of kaolin, calcium carbonate, bentonite, talc, and combinations thereof, preferably kaolin or calcium carbonate, and more preferably calcium carbonate.

The binder may be a water-dispersible or water-soluble binder. In some embodiments, the water-dispersible binder is a latex binder. In some embodiments, the water-soluble binder is a starch, PVOH, a cellulose derivate such as CMC, a protein, or seaweed. An advantage of using a water-soluble binder is that the laminate will be even more easy to recycle.

In some embodiments, the grammage of the mineral coating layer is in the range of 4-20 g/m², more preferably in the range of 6-14 g/m².

The mineral coating layer may preferably be applied in at least two different coating steps with drying of the coated film between the steps.

The PPS (Parker Print-Surf) smoothness according to ISO 8791-4 of the mineral coating layer is preferably less than 5 μm. The Cobb-Unger value (30s, bs) of the mineral coating layer is preferably less than 20 g/m², preferably in the range of 1-20 g/m², and more preferably in the range of 5-15 g/m², wherein the Cobb-Unger value is a measure of the oil absorption and measured by the SCAN-P 37:77 (30 seconds) method.

In some embodiments, the inventive packaging laminate comprises a barrier coating layer. The barrier coating layer is preferably arranged between the base layer and the metallized film layer. In some embodiments the barrier coating layer is in direct contact with the base layer. The barrier coating layer may be applied to the base layer before the metallized film layer is laminated to the barrier coating layer.

The water-soluble polymer of the barrier coating layer of the barrier coating layer is soluble in cold water or soluble in water after heating to a temperature below 100° C. for a given period of time. The water solubility of the barrier coating layer improves the separation of the metallized film layer from the base layer during repulping.

In some embodiments, the water-soluble polymer of the barrier coating layer is selected from the group of polyvinyl alcohol (PVOH), a copolymer of ethylene and polyvinyl alcohol, starch, carboxymethylcellulose and combinations thereof. In some embodiments, the water-soluble polymer of the barrier coating layer is PVOH.

The PVOH may for example have a degree of hydrolysis in the range of 80-99 mol %, preferably in the range of 85-98 mol %. The crystallinity of the PVOH is preferably less than 0.6, preferably less than 0.5, and more preferably less than 0.4 as determined by wide-angle x-ray scattering.

In some embodiments, the barrier coating layer comprises at least 50 wt % PVOH, preferably at least 70 wt % PVOH, based on the total dry weight of the barrier coating layer.

The PVOH may be an unmodified PVOH or a modified PVOH. The modified PVOH may preferably be an ethylene modified PVOH.

The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 85-99 mol %. Furthermore, the PVOH may preferably have a viscosity above 5 mPaxs in a 4% aqueous solution at 20° C. DIN 53015/JIS K 6726 (with no additives and with no change in pH, i.e. as obtained when dispersed and dissolved e.g. in distilled water). Examples of useful products are, e.g., Kuraray Poval™ 4-98, Poval™ 6-98, Poval™ 10-98, Poval™ 20-98, Poval™ 30-98, or Poval™ 56-98 or mixtures of these. From the less hydrolysed grades, Poval™ 4-88, Poval™ 6-88, Poval™ 8-88, Poval™ 18-88, Poval™ 22-88, or e.g. Poval™ 49-88 are preferred. The PVOH preferably has an ash content of less than 0.9 wt %, preferably less than 0.7 wt %, less than 0.4 wt % or less than 0.2 wt %.

To minimize the risk of pinholes in the barrier coating layer, the barrier coating layer may preferably be applied in at least two different coating steps with drying of the coated film between the steps. In some embodiments, the barrier coating layer is multilayered and at least one layer contains a low molecular weight PVOH. This will further facilitate subsequent release of the metallized film layer from the paper or paperboard base layer during repulping. Useful PVOH grades include, but are not limited to Kuraray Poval™ 4-98, Poval™ 4-88, and Poval™ 3-85.

The barrier coating layer is preferably formed by means of a liquid film coating process, i.e. in the form of an aqueous solution or dispersion which, on application, is spread out to a thin, uniform layer on a substrate and thereafter dried. The barrier coating layer can be applied by contact or non-contact coating methods. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating.

In some embodiments, at least one barrier coating layer is applied in the form a foam. Foam coating is advantageous as it allows for film forming at higher solids content and lower water content compared to an unfoamed coating. The lower water content of a foam coating also reduces the problems with rewetting of the substrate. The foam may be formed using a polymeric or non-polymeric foaming agent. Examples of polymeric foaming agents include PVOH, hydrophobically modified starch, preferably hydroxypropylated starch or starch esters, and hydrophobically modified ethyl hydroxyethyl cellulose. In a more specific embodiment, a first PVOH layer is applied in form of a foam, and the foam is collapsed before final drying. The foam coated PVOH layer is then coated with foamed or non-foamed PVOH layer in a second step. The second coat minimizes the risk of remaining pinholes in the barrier coating.

The coat weight of the barrier coating layer may typically be 20 g/m² or less. In some embodiments, the coat weight of the barrier coating layer is 15 g/m² or less, more preferably 12 g/m² or less. The coat weight of the barrier coating layer may generally be in the range of 1-20 g/m². In some embodiments, the coat weight of the barrier coating layer is in the range of 2-15 g/m², more preferably in the range of 3-12 g/m².

In some embodiments, a cross-linking agent is added to the barrier coating layer. A cross-linking agent can improve water resistance and adhesion of the barrier coating layer. Suitable cross-linking agents include, but are not limited to, glyoxal, citric acid, glutaraldehyde. The concentration of the cross-linking agent may for example be 1-20 wt %, preferably 1-15 wt %, based on the barrier coating layer weight.

In some embodiments, the barrier coating layer further comprises water-insoluble particles in an amount of less than 30 wt %, based on the dry weight of the barrier coating layer. The term water-insoluble as used herein means that the particles are insoluble in water at 23° C. and pH 7-8. In some embodiments, the water-insoluble particles are microfibrillated cellulose (MFC) or cellulose nanocrystals. In a preferred embodiment, the barrier coating layer coating comprises 70-100 wt %

PVOH and 30-0 wt % MFC or cellulose nanocrystals. The MFC or cellulose nanocrystals provides reinforcement and improves mechanical properties of the PVOH.

In some embodiments, the coat weight of the barrier coating layer is in the range of 0.1-15 g/m², preferably in the range of 0.1-10 g/m², more preferably in the range of 0.1-8 g/m², and more preferably in the range of 0.1-6 g/m².

In some embodiments, the coat weight of the barrier coating layer is in the range of 0.5-15 g/m², preferably in the range of 0.5-10 g/m², more preferably in the range of 1-8 g/m², and more preferably in the range of 2-6 g/m².

The metallized film layer comprises a metallization layer formed on a substrate film comprising a polyethylene selected from the group consisting of medium-density polyethylene (MDPE), high-density polyethylene (HDPE) and combinations thereof. In some embodiments, only one of the surfaces of the substrate film is metallized. In some embodiments, both surfaces of the substrate film are metallized. In some preferred embodiments, a metallized surface of the metallized film layer is attached to the inner side of the base layer by the tie layer. This configuration is advantageous since placing the metallized film layer with the sensitive metallized surface facing the base layer helps protect the surface from damage during further processing and handling of the packaging laminate.

The metallized film layer is attached to the paper or paperboard base layer, or to a possible barrier coating layer, by a tie layer. The tie layer is a polymer layer formed of a polyethylene selected from the group consisting of a low-density polyethylene (LDPE), a linear low-density polyethylene (LLDPE), a polyethylene ionomer, a polyethylene plastomer and combinations thereof. The purpose of the tie layer is to bind the metallized film layer to the paper or paperboard base layer, or optionally to a possible barrier coating layer.

The tie layer is formed of a polyethylene type having a lower density and melting temperature than the substrate film of the metallized film layer.

In some embodiments, the tie layer has a density of 0.925 g/cm³ or lower, preferably 0.920 g/cm³ or lower.

In some embodiments, the tie layer has a density of in the range of 0.850-0.925 g/cm³, preferably in the range of 0.900-0.920 g/cm³, and more preferably in the range of 0.900-0.915 g/cm³.

In some embodiments, the tie layer is formed of a polyethylene independently selected from the group consisting of a low-density polyethylene (LDPE), a linear low-density polyethylene (LLDPE) and combinations thereof.

In some embodiments, the low-density polyethylene (LDPE), linear low-density polyethylene (LLDPE), polyethylene ionomer, or polyethylene plastomer comprises a polyethylene functionalized with acid or anhydride groups. In some embodiments, the low-density polyethylene (LDPE), linear low-density polyethylene (LLDPE), polyethylene ionomer, or polyethylene plastomer comprises at least 10 wt %, preferably at least 20 wt %, at least 30 wt %, at least 40 wt % or at least 50 wt %, of the polyethylene functionalized with acid or anhydride groups. In some embodiments, the low-density polyethylene (LDPE), linear low-density polyethylene (LLDPE), polyethylene ionomer, or polyethylene plastomer consists of the polyethylene functionalized with acid or anhydride groups. The acid groups may preferably be carboxylic acids. In some embodiments, the low-density polyethylene (LDPE), linear low-density polyethylene (LLDPE), polyethylene ionomer, or polyethylene plastomer is a polyethylene functionalized with acid or anhydride groups grafted on the polymer backbone. In some embodiments, the polyethylene is functionalized with maleic anhydride. In some embodiments, the polyethylene is functionalized with itaconic acid or itaconic anhydride. The presence of the grafted acid or anhydride groups allows the tie-layer to bind covalently to the surface of the base layer or barrier coating layer. In some embodiments, the low-density polyethylene (LDPE), linear low-density polyethylene (LLDPE), polyethylene ionomer, or polyethylene plastomer is a copolymer of polyethylene with acid or anhydride functionalized monomers. In some embodiments, the copolymer of polyethylene with acid or anhydride functionalized monomers is an ethylene and acrylic acid (EAA) copolymer resin or an ethylene and methacrylic acid (EMA) copolymer resin or a combination thereof. In some embodiments, the copolymer of polyethylene with acid or anhydride functionalized monomers is an ethylene and itaconic acid copolymer resin or an ethylene and itaconic anhydride copolymer resin. The presence of the acid or anhydride groups allows the tie-layer to bind covalently to the surface of the base layer or barrier coating layer. In some embodiments, the degree of functionalization of the polyethylene functionalized with acid or anhydride groups is in the range of 0.1 wt % or higher, preferably 1 wt % or higher. The degree of functionalization of the polyethylene functionalized with acid or anhydride groups is preferably such that the content of acid or anhydride groups is 15 wt % or less, preferably 10 wt % or less, and more preferably 5 wt % or less. A degree of functionalization in the range of 0.1 wt % or higher, or 1 wt % or higher, but 15 wt % or less, or 10 wt % or less, or 5 wt % or less, is preferred since it provides excellent adhesion to a metallized surface, but still allows for the reject to be classified and recycled as a mono-material, i.e. as a single material. Forming the tie layer of an acid or anhydride functionalized polyethylene is particularly useful in embodiments where a metallized surface of the metallized film layer is attached to the inner side of the base layer by the tie layer. Metallized surfaces may often exhibit poor adhesion to polymeric coatings, however, the present inventors have found that acid or anhydride functionalized polyethylene, even with a low degree of acid or anhydride functionalization provides excellent adhesion to a metallized surface of the metallized film layer of the present invention. In some embodiments, the polyethylene functionalized with acid or anhydride groups is applied to the metallized surface of the metallized film layer in the form of a dispersion coating to form the tie layer. The dispersion coating may preferably be an aqueous dispersion coating. Dispersion coating of the tie layer with polyethylene functionalized with acid or anhydride groups results in a layer which is easier to disintegrate during repulping than a corresponding layer applied by extrusion coating. A tie layer formed of an acid or anhydride functionalized polyethylene results in a layer having an acidic surface pH, i.e. a surface pH below 7. Accordingly, in some embodiments, the tie layer has a surface pH below 7, preferably below 5. The surface pH is measured on a dry tie layer surface. The surface pH is measured using fresh pure water which is placed on the surface. Five parallel measurements are performed and the average pH value is calculated. The sensor is flushed with pure or ultra-pure water and the paper sample is then placed on the moist/wet sensor surface and pH is recorded after 30 s. Standard pH meters are used for the measurement.

In some embodiments, the tie layer has a melting temperature in the range of 90-125° C., preferably in the range of 90-120° C.

In some embodiments, the tie layer has a melting temperature in the range of 100-125° C., preferably in the range of 105-120° C.

In some embodiments, the polyethylene of the tie layer is an LDPE having a melting temperature in the range of 100-120° C., preferably in the range of 105-115° C., and more preferably in the range of or 105-110° C.

In some embodiments, the polyethylene of the tie layer is an LDPE having a melting temperature in the range of 116-125° C., preferably in the range of 120-125° C.

In some embodiments, the polyethylene of the tie layer is a polyethylene functionalized with acid or anhydride groups, having a melting temperature in the range of 90-112° C., preferably in the range of 92-105° C.

In some embodiments, the tie layer has a grammage in the range of 1-15 g/m², preferably in the range of 1-10 g/m².

The metallized film layer is provided on the outside thereof with a heat-sealing layer. The heat-sealing layer is a polymer layer formed of a polyethylene selected from the group consisting of a low-density polyethylene (LDPE), a linear low-density polyethylene (LLDPE), a polyethylene ionomer, a polyethylene plastomer and combinations thereof. The purpose of the heat-sealing layer is to allow the paper or paperboard packaging laminate to be heat sealed during conversion into packaging containers.

The heat-sealing layer is formed of a polyethylene type having a lower density and melting temperature than the substrate film of the metallized film layer.

In some embodiments, the heat-sealing layer has a density of 0.925 g/cm³ or lower, preferably 0.920 g/cm³ or lower.

In some embodiments, the heat-sealing layer is formed of a polyethylene independently selected from the group consisting of a low-density polyethylene (LDPE), a linear low-density polyethylene (LLDPE) and combinations thereof.

In some embodiments, the heat-sealing layer has a melting temperature in the range of 100-125° C., preferably in the range of 105-120° C.

In some embodiments, the polyethylene of the heat-sealing layer is an LDPE having a melting temperature in the range of 100-120° C., preferably in the range of 105-115° C., and more preferably in the range of or 105-110° C.

In some embodiments, the polyethylene of the heat-sealing layer is an LDPE having a melting temperature in the range of 116-125° C., preferably in the range of 120-125° C.

In some embodiments, the heat-sealing layer has a grammage in the range of 5-30 g/m², preferably in the range of 5-20 g/m².

In some embodiments, the polyethylene composition of the tie layer and the heat-sealing layer is the same.

The metallized film layer comprises a metallization layer formed on a substrate film comprising a polyethylene selected from the group consisting of medium-density polyethylene (MDPE), high-density polyethylene (HDPE) and combinations thereof. The metallization layer is applied to at least one surface of the substrate film. The metallized film layer preferably further improves the oxygen barrier and/or water vapor barrier properties of the laminate.

The substrate film is a film suitable for applying a continuous of substantially continuous metallization layer having a thickness in the range of 1-500 nm thereon. The substrate film preferably comprises a film or sheet shaped material having a smooth, dense and relatively low porous surface on which the metallization layer can be applied. The substrate film should preferably have few or no pinholes. The amount of pinholes in a film or sheet shaped substrate film may for example be determined according to standard EN13676:2001.

In some embodiments, the substrate film is a machine-oriented or a biaxially-oriented MDPE or HDPE film. This improves the mechanical properties of the substrate film and provides more resistance for the tie layer and heat sealing layers.

The substrate film may consist of a single layer of material or it can be a multilayer structure comprised of two or more layers of the same or different materials. In some embodiments, the grammage of the substrate film is in the range of 10-60 g/m², preferably in the range of 10-40 g/m², more preferably in the range of 10-30 g/m².

In some embodiments, the substrate film of the metallized film layer has a density of 0.926 g/cm³ or higher, preferably 0.930 g/cm³ or higher.

In some embodiments, the substrate film of the metallized film layer has a density at least 0.010 g/cm³ higher, preferably at least 0.015 g/cm³ higher, and more preferably at least 0.020 g/cm³ higher, than the density of the tie layer and the heat-sealing layer.

In some embodiments, the substrate film of the metallized film layer has a melting temperature in the range of 126-135° C., preferably in the range of 127-130° C.

In some embodiments, the substrate film of the metallized film layer has a melting temperature at least 2° C. higher, preferably at least 3° C. higher, and more preferably at least 5° C. higher, than the melting temperature of the tie layer and the heat-sealing layer.

The lower melting temperatures of the tie layer and heat-sealing layer as compared to the substrate film of the metallized film layer is important as it allows for lamination of the metallized film layer to the base layer using the tie layer, and subsequent heat-sealing during conversion to packaging containers, to be performed at a lower temperature. The higher melting temperature of the MDPE or HDPE of the substrate film allows for the thermal movement (i.e. expansion and shrinkage) to be reduced and for the dimensional stability of the substrate film to be retained to a greater extent during heating and cooling, which in turn reduces stress on the thin and sensitive metallization layer disposed on the substrate. Thermal movement might otherwise cause pin holes in the metallization layer that affect the gas barrier properties of the packaging laminate negatively.

Metallization refers to a family of processes used to deposit layers of metals or metal oxides atom-by-atom or molecule-by-molecule on a solid surface. Multiple layers of the same or different materials can be combined. The process can be further specified based on the vapor source; physical vapor deposition (PVD) uses a liquid or solid source and chemical vapor deposition (CVD) uses a chemical vapor.

In some embodiments, the metallization layer is formed by vapor deposition of a metal or metal oxide on the substrate film, preferably by physical vapor deposition (PVD) or chemical vapor deposition (CVD).

In some embodiments, only one of the surfaces of the substrate film is metallized. In some embodiments, both surfaces of the substrate film are metallized.

In some embodiments, the metallization layer comprises a metal or metal oxide selected from the group consisting of aluminum, magnesium, silicon, copper, aluminum oxides, magnesium oxides, silicon oxides, and combinations thereof, preferably an aluminum oxide. Aluminum oxide metallization layers also known as AlOx coatings can provide similar barrier properties as aluminum metal coatings, but have the added advantage of thin AlOx coatings being transparent to visible light.

The metallization layer of the present invention may have a thickness in the range of from 1 to 500 nm. In some embodiments, the metallization layer has a layer thickness in the range of 1-100 nm, preferably in the range of 10-100 nm, and more preferably in the range of 20-50 nm. In some embodiments, the metallization layer has a basis weight in the range of 50-250 mg/m², preferably in the range of 75-150 mg/m².

One preferred type of metallization coating, often used for its barrier properties, in particular water vapour barrier properties, is an aluminum metal physical vapour deposition (PVD) coating. Such a coating, substantially consisting of aluminum metal, may typically have a thickness of from 10 to 50 nm. The thickness of the metallization layer corresponds to less than 1% of the aluminum metal material typically present in an aluminum foil of conventional thickness for packaging, i.e. 6.3 μm.

In some embodiments, the substrate film is subjected to corona discharge, plasma, or flame treatment before the metallization layer is applied, in order to improve adhesion of the metallization layer.

In some embodiments, the metallized film layer comprises a primer layer between the substrate film and the metallization layer.

The primer layer preferably acts to improve adhesion, level out unevenness, and fill pores and pinholes present in the substrate film. In some embodiments, the primer layer comprises a polymer selected from the group consisting of a polyvinyl alcohol, a modified polyvinyl alcohol, a polysaccharide and a modified polysaccharide, a polyurethane, acrylic resins, ethylene and acrylic acid (EAA) copolymer resins, epoxide resins, vinyl ethers, vinyl esters, styrene, acrylonitrile, ethylene vinyl alcohol (EVOH) resins, or combinations thereof, preferably polyvinyl alcohol.

In some embodiments, the basis weight of the primer layer is in the range of 0.1-12 g/m², preferably in the range of 0.5-8 g/m², more preferably in the range of 1-6 g/m².

To minimize the risk of pinholes in the primer layer, the primer layer may preferably be applied in at least two different coating steps with drying of the coated film between the steps.

The primer layer can be applied by contact or non-contact coating methods. Examples of useful coating methods include, but are not limited to rod coating, curtain coating, film press coating, cast coating, size press coating, flexographic coating, gate roll coating, spray coating, gravure coating or reverse gravure coating.

In some embodiments, the tie layer is in direct contact with the metallized surface of the metallized film layer. In other words, the tie layer is applied directly onto the metallized surface, without any intermediate layers in between. In some embodiments, the tie layer will also act as a topcoat layer that protects the thin and sensitive metallization layer from damage during handling and transport.

In some embodiments, the metallized film layer further comprises a topcoat layer on top of the metallization layer. The topcoat layer protects the thin and sensitive metallization layer from damage during handling and transport. The topcoat layer may for example be an extruded or laminated polyolefin layer, preferably a polyethylene layer.

The total grammage of the metallized film layer will depend mainly on the substrate film used. In some embodiments, the grammage of the metallized film layer is in the range of 10-60 g/m², preferably in the range of 10-40 g/m², more preferably in the range of 10-30 g/m².

The paper or paperboard based packaging laminate may further comprise a moisture barrier layer disposed on the side of the paper or paperboard base layer opposite to the side on which the metallized film layer is disposed. The side of the paper or paperboard base layer opposite to the side on which the metallized film layer is disposed is referred to herein as the outer side of the paper or paperboard base layer as it is intended to form the outside of a packaging container formed by the packaging laminate. The moisture barrier layer protects the outer side of the paper or paperboard base layer from moisture, e.g. in the form of water vapor or condensation formed on the laminate surface.

Thus, in some embodiments, the paper or paperboard based packaging laminate further comprises a moisture barrier layer arranged on the outer side of the paper or paperboard base layer. In some embodiments, the moisture barrier layer comprises a dispersion barrier layer or an extrusion coated polyolefin layer. In preferred embodiments, the moisture barrier layer comprises a dispersion barrier layer. Dispersion barrier layers have the advantage over extrusion coated polyolefin layers that they are generally more readily repulped and recycled. The moisture barrier layer may for example comprise a styrene acrylate latex (SA latex), a styrene butadiene latex (SB latex) or a polyolefin dispersion such as a polyethylene latex. Preferably the moisture barrier layer comprises SA latex or SB latex.

In some embodiments, the moisture barrier layer comprises a modified starch and a hydrophobic agent selected from the group of wax, styrene maleic anhydride (SMA), fatty resins, tall oil fatty acids, bee wax, triglyceride emulsions, alkyl ketene dimers (AKDs), a copolymer of ethylene and polyvinyl alcohol, and combinations thereof.

In some embodiments, the moisture barrier layer further comprises a pigment. In some embodiments, the moisture barrier layer comprises 40-100 wt % latex and 0-60 wt % of a pigment, based on dry weight of the moisture barrier layer.

The grammage of the moisture barrier layer is preferably in the range of 4-30 gsm, and more preferably in the range of 5-20 gsm.

The inventive paper or paperboard based packaging laminate combines several advantageous properties. The metallized film layer has been found to provide paper and paperboard packaging laminates with excellent gas barrier properties, e.g. for oxygen and carbon dioxide, and water vapor barrier properties, particularly when combined with a barrier coating layer, such as a polyvinyl alcohol (PVOH) layer. There is a demand for improved solutions to replace aluminum foils and polyolefin films as barrier layers in packaging laminates, such as liquid packaging board, with alternatives that facilitate re-pulping and recycling of the used packaging laminates. The high proportion of polyethylene in the reject obtained when repulping the inventive packaging laminate is advantageous since it allows for the reject to be classified and recycled as a mono-material, i.e. as a single material. The combination of a barrier coating layer and a metallized film layer according to embodiments of the present disclosure has been found to further facilitate re-pulping and recycling of the used packaging laminates. The barrier coating layer comprising a water-soluble polymer in an amount of at least 50 wt % has been found to allow for effective separation of the metallized film layer from the base layer during repulping. Furthermore, as polyethylene is the major constituent of the metallized film layer as well as the tie layer and the heat-sealing layer, these three layers can be conveniently recycled in the same fraction without further polymer separation steps. Also, the low amount of metal in the metallization layer leads to a significantly lower remaining ash content upon combustion of the inventive packaging laminate as compared to conventional packaging laminates using a thicker aluminum foil.

In some embodiments, the paper or paperboard based packaging laminate has an oxygen transfer rate (OTR), measured according to the standard ASTM D-3985 at 50% relative humidity and 23° C., of less than 5 cc/m²/24 h, preferably less than 3 cc/m²/24 h, and more preferably less than 2 cc/m²/24 h.

In some embodiments, the paper or paperboard based packaging laminate has an oxygen transfer rate (OTR), measured according to the standard ASTM D-3985 at 90% relative humidity and 38° C., of less than 15 cc/m²/24 h, preferably less than 10 cc/m²/24 h, and more preferably less than 5 cc/m²/24 h.

In some embodiments, the paper or paperboard based packaging laminate has a light transmittance of less than 0.5%, preferably of less than 0.2 or less than 0.1% as measured in accordance with Cary 100 Conc spectrophotometer with DRA CA301 Integrating Sphere in the transmission port at a wave length of 200 to 700 nm.

In some embodiments, the paper or paperboard based packaging laminate has a water vapor transfer rate (WVTR), measured according to the standard ASTM F1249 at 50% relative humidity and 23° C., of less than 5 g/m²/24 h, and preferably less than 0.5 g/m²/24 h.

In some embodiments, the paper or paperboard based packaging laminate has a water vapor transfer rate (WVTR), measured according to the standard ASTM F1249 at 90% relative humidity and 38° C., of less than 5 g/m²/24 h, and preferably less than 1 g/m²/24 h.

In some embodiments, the paper or paperboard based packaging laminate has a reject rate according to PTS RH 021/97 of less than 30%, preferably less than 20%, more preferably less than 10%.

In some embodiments, the paper or paperboard based packaging laminate has a remaining ash content of less than 10 wt %, preferably less than 7 wt %, 5 wt % or 2 wt %, upon combustion at 525° C. or 900° C. in accordance with Tappi standard T211 or T413 respectively.

According to a second aspect illustrated herein, there is provided a heat-sealed container, particularly a liquid packaging container, comprising a paper or paperboard based packaging laminate according to the first aspect.

In some embodiments, the inner side of the base layer, to which the metallized film layer and optionally the barrier coating layer, is attached, faces the inside of the container.

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A paper or paperboard based packaging laminate comprising:
a paper or paperboard base layer,
a tie layer,
a metallized film layer, and
a heat-sealing layer,
wherein the base layer has an inner side and an outer side, the metallized film layer attached to the inner side of the base layer by the tie layer, and the heat-sealing layer attached to the metallized film layer,
wherein the tie layer and the heat-sealing layer are each formed of a polyethylene independently selected from a group consisting of: a low-density polyethylene (LDPE), a linear low-density polyethylene (LLDPE), a polyethylene ionomer, a polyethylene plastomer, and combinations thereof, and
wherein the metallized film layer comprises a metallization layer formed on a substrate film comprising a polyethylene selected from a group consisting of: medium-density polyethylene (MDPE), high-density polyethylene (HDPE), and combinations thereof.

2. The paper or paperboard based packaging laminate according to claim 1, wherein the base layer comprises at least 10 wt % of recycled fibers, based on a total fiber weight of the base layer.

3. The paper or paperboard based packaging laminate according to claim 1, wherein the base layer comprises a paper or paperboard layer, and a mineral coating layer on the inner side, or the outer side, or both of the paper or paperboard layer.

4. The paper or paperboard based packaging laminate according to claim 1, further comprising:
a barrier coating layer arranged between the base layer and the tie layer,
wherein said barrier coating layer comprises a water-soluble polymer in an amount of at least 50 wt %, based on a dry weight of the barrier coating layer.

5. The paper or paperboard based packaging laminate according to claim 4, wherein the water-soluble polymer of the barrier coating layer is selected from a group consisting of: polyvinyl alcohol, a copolymer of ethylene and polyvinyl alcohol, starch, carboxymethylcellulose and combinations thereof.

6. The paper or paperboard based packaging laminate according to claim 4, wherein a coat weight of the barrier coating layer is in a range of 0.5-15 g/m².

7. The paper or paperboard based packaging laminate according to claim 1, wherein the tie layer and the heat-sealing layer each have a density of 0.925 g/cm³ or lower.

8. The paper or paperboard based packaging laminate according to claim 1, wherein the tie layer and the heat-sealing layer are each formed of a polyethylene independently selected from a group consisting of: low-density polyethylene (LDPE), linear low-density polyethylene (LLDPE), polyethylene ionomer, polyethylene plastomer, and combinations thereof.

9. The paper or paperboard based packaging laminate according to claim 1, wherein the tie layer is formed of a polyethylene functionalized with acid or anhydride groups.

10. The paper or paperboard based packaging laminate according to claim 9, wherein the polyethylene functionalized with acid or anhydride groups comprises an ethylene and acrylic acid (EAA) copolymer resin, or an ethylene and methacrylic acid (EMA) copolymer resin, or a combination thereof.

11. The paper or paperboard based packaging laminate according to claim 9, wherein the polyethylene functionalized with acid or anhydride groups has a content of acid or anhydride groups of 15 wt % or less.

12. The paper or paperboard based packaging laminate according to claim 9, wherein the tie layer is formed by dispersion coating of the polyethylene functionalized with acid or anhydride groups.

13. The paper or paperboard based packaging laminate according to claim 1, wherein the tie layer and the heat-sealing layer each have a melting temperature in a range of 100-125° C.

14. The paper or paperboard based packaging laminate according to claim 1, wherein the substrate film of the metallized film layer has a density of 0.926 g/cm³ or higher.

15. The paper or paperboard based packaging laminate according to claim 1, wherein the substrate film of the metallized film layer has a melting temperature in a range of 126-135° C.

16. The paper or paperboard based packaging laminate according to claim 1, wherein only one surface of the substrate film is metallized.

17. The paper or paperboard based packaging laminate according to claim 1, wherein two surfaces of the substrate film are metallized.

18. The paper or paperboard based packaging laminate according to claim 1, wherein a metallized surface of the metallized film layer is attached to the inner side of the base layer by the tie layer.

19. The paper or paperboard based packaging laminate according to claim 1, wherein the metallized film layer comprises a metallization layer formed by vapor deposition of a metal or metal oxide on the substrate film.

20. The paper or paperboard based packaging laminate according to claim 1, wherein the tie layer is in direct contact with the metallized film layer.

21. The paper or paperboard based packaging laminate according to claim 1, wherein the metallized film layer comprises a topcoat layer on top of the metallization layer.

22. The paper or paperboard based packaging laminate according to claim 1, further comprising:
a moisture barrier layer arranged on an outer side of the paper or paperboard base layer, wherein the moisture barrier layer comprises a dispersion barrier layer or an extrusion coated polyolefin layer.

23. The paper or paperboard based packaging laminate according to claim 1, wherein the paper or paperboard based packaging laminate has_an oxygen transfer rate (OTR), measured according to standard ASTM D-3985 at 50% relative humidity and 23° C., of less than 5 cc/m²/24 h.

24. The paper or paperboard based packaging laminate according to claim 1, wherein the paper or paperboard based packaging laminate has a water vapor transfer rate (WVTR), measured according to standard ASTM F1249 at 50% relative humidity and 23° C., of less than 5 g/m²/24 h.

25. The paper or paperboard based packaging laminate according to claim 1, wherein the paper or paperboard based packaging laminate has a reject rate according to PTS RH 021/97 of less than 30%.

26. A heat-sealed container comprising:
the paper or paperboard based packaging laminate according to claim 1.

27. The heat-sealed container according to claim 26, wherein the inner side of the base layer faces an inside of the container.
